(19) United States
(12) Patent Application Publication
(10) Pub. No.: US 2002/0153992 A1
(43) Pub. Date: Oct. 24, 2002

(54) Polymer PTC element

(75) Inventors: Katsumi Kobayashi, Tokyo (JP); Hisanao Tosaka, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Tokyo (JP)

(21) Appl. No.: 10/124,456

(22) Filed: Apr. 18, 2002

(30) Foreign Application Priority Data
Apr. 18, 2001 (JP) 2001-119778

(51) Int. Cl. H01C 7/10

(52) U.S. Cl. 338/22 R

(57) ABSTRACT

A polymer PTC element includes:

an element body including a polymer and a conductive material dispersively mixed in this polymer; and a pair of electrode foils in each of which at least one surface is roughened and this surface is applied with an Au flash plating and which are bonded on both surfaces of the element body respectively with the roughened surfaces facing the element body.

Therefore, electrical resistance in connecting portions of the element body and the electrodes is sufficiently lowered and the electrical resistance is not increased due to environmental and aging changes and so on.

### BACKGROUND OF THE INVENTION

1. Field of the Invention

The present invention relates to a polymer PTC element which shows a positive resistance temperature coefficient, for protecting a battery and a circuit against overcurrent, and more particularly, to a polymer PTC element appropriate as an element for protecting a circuit connected to a battery pack of a cellular phone, a video camera, a computer, and so on against overcurrent and overheat.

2. Description of Related Art

A polymer PTC element is considered to be a kind of a PTC (Positive Temperature Coefficient) element. As a conventional example of this polymer PTC element, such a polymer PTC element is known which is produced in a method disclosed in Japanese Patent Laid-open No. Hei 8-246183, and in which electrolytic copper foils or electrolytic nickel foils, each having one roughened surface, are bonded on both surfaces of an element body respectively with the roughened surfaces facing the element body to form electrodes of the element, or electrolytic copper foils subjected to surface-roughening and electrolytic nickelic treatment are bonded on both surfaces of the element body respectively with the roughened surfaces facing the element body to form electrodes of the element.

Furthermore, as another conventional example of this polymer PTC element, the one disclosed in Japanese Utility Model Laid-open No. Hei 2-146401 is known. In this official gazette, disclosed is the structure in which soft-solder plating layers 118 are melted to connect electrodes 114 provided in an element body 112 and lead terminals 116 with each other by soft soldering as shown in FIG. 7.

However, the electrodes formed by the method disclosed in Japanese Patent Laid-open No. Hei 8-246183 has a disadvantage that it is easily degraded since it is formed of copper or nickel and is subject to oxidation and so on so that electrical resistance in connecting portions between the electrodes and the element body is increased in accordance with the elapse of time. Especially, when copper is used to form the electrodes, the increase in the electrical resistance is prominent, though it costs low.

Meanwhile, especially when lead terminals and electrodes are simply connected by ordinary soft soldering in a polymer PTC element operating at a low temperature, there exists a disadvantage that a poor characteristic is caused due to thermal degradation of the polymer PTC element since melting temperature of a soft solder is about 200° C. or higher. Moreover, even when the soft-solder plating layers 118 are melted to connect them as in Japanese Utility Model Laid-open No. Hei 2-146401 as described above, the problem of the thermal degradation cannot be basically solved since melting temperature is also high in this case.

### SUMMARY OF THE INVENTION

In consideration of the above-described facts, it is a first object of the present invention to provide a polymer PTC element whose electrical resistance in a connecting portion between an element body and an electrode is sufficiently low, and in addition, which has a stable electrical characteristic causing no increase in the electrical resistance in this connecting portion even with environmental changes, aging, and so on. Furthermore, it is a second object of the present invention to provide a polymer PTC element not only eliminating the disadvantage of causing a poor characteristic due to thermal degradation but also satisfying solderability of a lead terminal.

According to one of the aspects of the present invention, provided is a polymer PTC element comprising: an element body including a polymer and a conductive material dispersively mixed in this polymer; and a pair of electrode foils in each of which at least one surface is roughened and this surface is applied with an Au (gold) flash plating and which are bonded, with these surfaces being faced with the element body, on both surfaces of the element body respectively.

The polymer PTC element as described above brings about the following effect.

The polymer PTC element according to this aspect is so structured that it comprises the element body including the polymer, and the conductive material dispersively mixed in this polymer and the pair of the electrode foils are bonded on this element body. Furthermore, at least one surface of each of this pair of the electrode foils is roughened, and in addition, this roughened surface is applied with the Au (gold) flash plating, and the pair of the electrode foils are bonded on both surfaces of the element body with the surfaces thereof, which are applied with the Au flash platings, being faced with the element body.

In short, the Au flash plating is applied on the roughened surface of each of the electrode foils to provide a layer made of gold, which is a stable material with low electrical resistance, in the connecting portion between the element body and the electrode foil of the polymer PTC element according to this aspect. This not only lowers the electrical resistance in this connecting portion sufficiently compared with a conventional example, but also reduces changes due to its environment and aging to eliminate increase in the electrical resistance in the connecting portion.

As a result, a stable electrical characteristic is obtainable, and furthermore, a low-cost electrolytic copper foil can be used, thereby enabling reduction in production cost of the polymer PTC element.

According to another aspect of the present invention, provided is a polymer PTC element comprising: an element body including a polymer and a conductive material dispersively mixed in this polymer; and a pair of electrode foils which are bonded on both surfaces of this element body respectively and in which surfaces thereof opposite this element body are applied with Au flash platings respectively.

The polymer PTC element as described above brings about the following effect.

The polymer PTC element according to this aspect is so structured that it comprises the element body including the polymer, and the conductive material dispersively mixed in this polymer and the pair of the electrode foils are bonded on this element body. Furthermore, the Au flash plating is applied on the surface of each of the electrode foils not facing this element body, namely, the surface of each of the electrode foils opposite the element body.

More specifically, as surface treatment of an electrode foil of a conventional polymer PTC element, soft-solder plating is employed, taking solderability between this electrode foil and an external connecting terminal such as a lead terminal into consideration. Then, after the electrode foil is bonded on an element body, soft-solder leveling is performed. However, thermal damage to the element body is worried about in this soft-solder leveling since the electrode foil comes in contact with a soft-solder melting portion whose temperature is 200° C. to 220° C.

Meanwhile, in soft-soldering the electrode foil with the external connecting terminal, it can be considered to employ electrical soft-solder plating including an Sn plating. However, in this case, though this electrical soft-solder plating can be performed more easily and costs lower when they are tumble-plated in the individual product form of the element body, the plating thickness needs to be 1 μm or more in this tumble plating, considering solderability.

When the plating is carried out under the condition of the plating thickness of 1 μm or more, the plating also adheres to a portion of the element body exposed in an end surface since the element body also has some degree of electrical conductivity, which may possibly result in production of a poor product.

On the other hand, in the Au flash plating according to this aspect, the temperature does not become high during the treatment, and therefore, there is no possibility of causing a poor characteristic of the element body due to thermal degradation. Moreover, solderability can be satisfied with a relatively small plating thickness of about 0.01 μm to about 0.1 μm, which prevents the plating from adhering to the end surface of the element body, thereby preventing the element body from being a poor product. Moreover, the characteristic of the polymer PTC element is not degraded due to a plating solution or the treatment temperature while the plating is applied. In addition, the small plating thickness can realize improvement in a process yield and relatively low cost production.

According to still another aspect of the present invention, provided is a polymer PTC element comprising: an element body including a polymer and a conductive material dispersively mixed in this polymer; and a pair of electrode foils which are bonded on both surfaces of the element body respectively and in which at least a surface of each of the electrode foils facing the element body is roughened and both surfaces thereof are applied with Au flash platings respectively.

The polymer PTC element as described above brings about the following effect.

The polymer PTC element according to this aspect is so structured that it comprises the element body including the polymer and the conductive material dispersively mixed in this polymer and the pair of the electrode foils are bonded on this element body. Furthermore, at least the surface of each of the pair of the electrode foils facing the element body is roughened and both surfaces of the electrode foils are applied with the Au flash platings.

More specifically, in a case the electrode foil is intended to be plated as a single object before the electrode foil is bonded on the element body, if soft-solder plating is employed, a soft solder adheres to the roughened surface, so that a poor characteristic such as decrease in bonding strength may possibly be caused. Therefore, one surface of the electrode foil must be completely masked during the treatment.

On the other hand, the Au flash plating according to this aspect not only eliminates the possibility of causing a poor characteristic owing to a thin plating thickness but also makes it possible to synchronously plate both of the surfaces, namely, the roughened surface to be bonded on the element body and the surface on which the external connecting terminal is connected. Especially, when considering the aspect of the present invention described above, gold can adhere to both of the surfaces of the electrode foil synchronously by one plating process, thereby simplifying production processes and further reducing production cost of the polymer PTC element.

### BRIEF DESCRIPTION OF THE DRAWINGS

FIG. 1 is a perspective view showing a polymer PTC element according to one embodiment of the present invention;

FIG. 2 is a graph showing the correlation between resistance and temperature of an element body in a first example of the polymer PTC element according to the embodiment of the present invention;

FIG. 3 is a graph showing the correlation between resistance and temperature of an element body in a second example of the polymer PTC element according to the embodiment of the present invention;

FIG. 4A is a cross sectional view showing a manufacture of the polymer PTC element according to the embodiment of the present invention and showing a state before the element body and electrode foils are connected with each other, and FIG. 4B is a cross sectional view showing the manufacture of the polymer PTC element according to the embodiment of the present invention and showing a state after the element body and the electrode foils are connected with each other;

FIG. 5A is a perspective view showing the manufacture of the polymer PTC element according to the embodiment of the present invention and showing the state after the element body and the electrode foils are connected with each other, FIG. 5B is a perspective view showing the manufacture of the polymer PTC element according to the embodiment of the present invention and showing a state before lead terminals are connected onto the electrode foils, and FIG. 5C is a perspective view showing the manufacture of the polymer PTC element according to the embodiment of the present invention and showing a state after the lead terminals are connected onto the electrode foils;

FIG. 6 is a graph showing the increase in electrical resistivity after thermo cycle tests are conducted on samples of the polymer PTC element; and

FIG. 7 is a perspective view showing a polymer PTC element according to a conventional art.

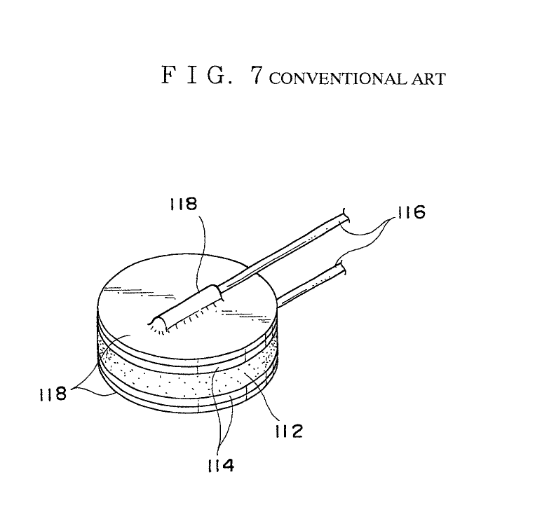

### DETAILED DESCRIPTION OF THE PREFERRED EMBODIMENTS

An embodiment of a polymer PTC element according to the present invention is explained below with reference to the drawings to clarify the present invention.

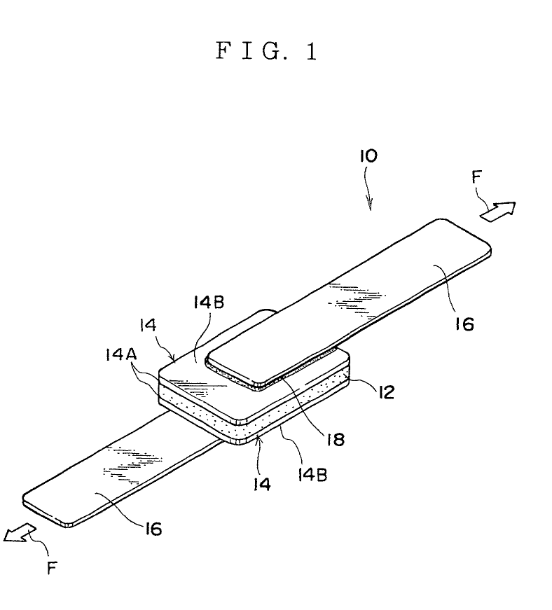

FIG. 1 is a perspective view showing a polymer PTC element 10 according to this embodiment. In this embodiment, a plate-like element body 12 constituted of a polymer and a conductive material dispersively mixed in this polymer constitutes a body portion of the polymer PTC element 10 shown in this drawing.

Note that an element body inclusive of a polymer synthesized using a metallocene catalyst and of conductive granules dispersively mixed in this polymer as a conductive material and having spike-shaped protrusions is employed as the element body 12 in the polymer PTC element 10 according to this embodiment, so that temperature change in a relatively low range of temperature can be detected. Specifically, the temperature of a resistance changing point of this element body 12 is set within a relatively low range of 60° to 120° C.

Moreover, electrode foils 14 for passing electricity are provided, being bonded on both of upper and lower surfaces of this element body 12 respectively. Surfaces of a pair of these electrodes foils 14 facing the element body 12, namely, surfaces bonded on the element body 12, are roughed to be surfaces 14A, and in addition, Au (gold) flash platings are applied on these surfaces facing the element body 12. The Au flash platings are also applied on surfaces 14B of the pair of these electrode foils 14 not facing the element body 12 respectively in order to enhance solderability.

As described above, at least the respective surfaces of the pair of the electrode foils 14 facing the element body 12 are roughed to be the surfaces 14A, and the Au flash platings are applied on both of the surfaces of the pair of these electrode foils 14 respectively. Incidentally, the pair of these electrode foils 14 are formed of electrolytic copper foils or electrolytic nickel foils and have a thickness of about 20 μm to about 40 μm, with the roughened surfaces having a surface roughness Ra of about 1.0 μm to about 1.5 μm, and the Au platings having a thickness of about 0.01 μm to 0.1μm.

Meanwhile, the pair of these electrode foils 14 bonded on the element body 12 respectively and a pair of lead terminals 16, each formed in a long and narrow plate shape, are connected by Sn (tin)—Bi (bismuth) alloy soft solders 18 respectively. In other words, the pair of the lead terminals 16 are connected on the upper and lower surfaces of the element body 12 respectively via the electrode foils 14 to constitute the polymer PTC element 10.

Next, it is explained why the element body inclusive of the polymer synthesized using the metallocene catalyst and of the conductive granules dispersively mixed in this polymer as the conductive material and having the spike-shaped protrusions is employed as the element body 12 according to this embodiment.

As characteristics required for the element body 12 of the polymer PTC element 10, such characteristics can be listed that room temperature resistivity is sufficiently low in its non-operating state at room temperature, that a change rate of resistivity in its operating state relative to the room temperature resistivity is sufficiently high, and that repeated operations cause a little change in the resistivity.

As a thermoplastic crystalline macromolecule which is a polymer for the element body 12 of the polymer PTC element 10, high-crystal and high-density polyethylene has been mainly used conventionally. This is because a higher-crystal macromolecule has a higher expansivity and a higher resistance change rate can be obtained in it. On the other hand, a lower-crystal macromolecule has a lower crystallization speed, which disables it to return to the original crystal state when it is cooled after melted, and the change in resistivity at room temperature is big, and therefore, it is difficult to employ it for the element body 12 due to its property.

However, one of the disadvantages of using the high-density polyethylene is its high operating temperature. Specifically, the operating temperature of the polymer PTC element when used as an overcurrent protective element becomes about 130° C. which is its melting point, and thermal influence to other electronic components on a circuit substrate cannot be sometimes ignored at this temperature. Furthermore, the operating temperature is also too high as an overheat protective component of a secondary battery.

Therefore, it has been decided to especially use linear low-density polyethylene (LLDPE) which is a polymer polymerized using the metallocene catalyst, in order to make it possible to maintain a good resistance recovery characteristic while maintaining the operating temperature at about 100° C. which is lower than that of the high-density polyethylene whose operating temperature is high.

This is because a small amount of low-density, low-molecular ingredient due to a narrow width of molecule distribution of the polymer which is brought about by the polymerization using this metallocene catalyst is considered to be one of the reasons the resistance recovery characteristic can be maintained. Specifically, a high-density ingredient is crystallized in a conventionally and generally used linear low-density polyethylene and crystallization is promoted with this ingredient as a crystal nucleus. On the other hand, in the polymer synthesized using the metallocene catalyst, it can be thought that, even when the polymer PTC element operates to melt the crystal, a characteristic change after that becomes small to reduce resisitivity change at room temperature since a crystal nucleus is uniformly made and grown.

As described above, the polymer synthesized using the metallocene catalyst is employed so that the operating temperature can be made lower than that of a conventional polymer PTC element. Accordingly, an element having a stable characteristic while maintaining low operating temperature, which has been conventionally difficult to realize, is obtainable.

Furthermore, the use of the conductive granules having the spike-shaped protrusions makes it possible to obtain a low room temperature resistance and a high resistance change rate at the same time.

Specifically, since the conductive granules having the spike-shaped protrusions are used, its shape allows a tunnel current to easily pass therethrough, so that the element body 12 with a relatively low room temperature resistance can be obtained compared with an element using spherical conductive granules. In addition, intervals between the conductive granules are large compared with those of the spherical conductive granules so that a larger resistance change can be obtained in its operating state.

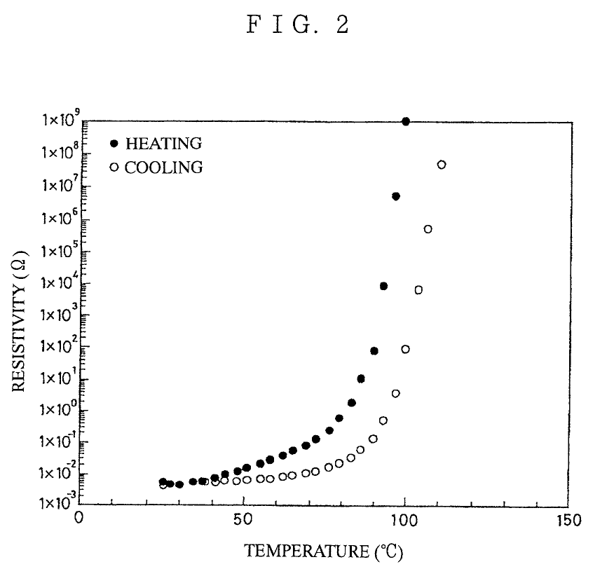

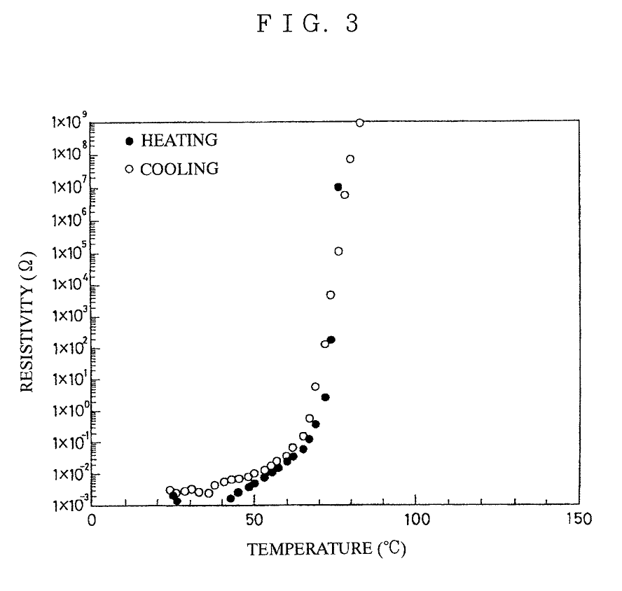

A graph showing the correlation between resistance and temperature of materials which can be used as the element body 12 according to this embodiment in a first example is shown in FIG. 2, and a graph showing the correlation between resistance and temperature of the same in a second example is shown in FIG. 3.

The first example shown in FIG. 2 out of these drawings presents hysteresis between heating and cooling, but it is in a tolerable range for this material to be used as the element body 12. Meanwhile, a low molecular organic compound is mixed in this material and this low molecular organic compound is made to be an operating material, so that a transition temperature (operating temperature) at which resistance increases at the time of heating can be made substantially equal to the temperature at which the resistance returns to a low value at the time of cooling, and a material having the characteristic shown in the graph in FIG. 3 can be obtained.

Next, production processes of the polymer PTC element 10 according to this embodiment are explained.

First, the element body 12 constituted of the polymer and the conductive material dispersively mixed in this polymer is made.

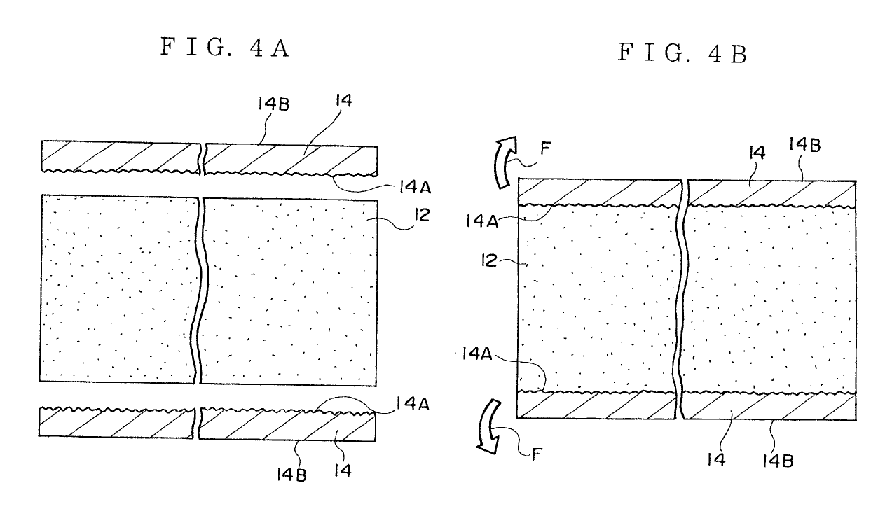

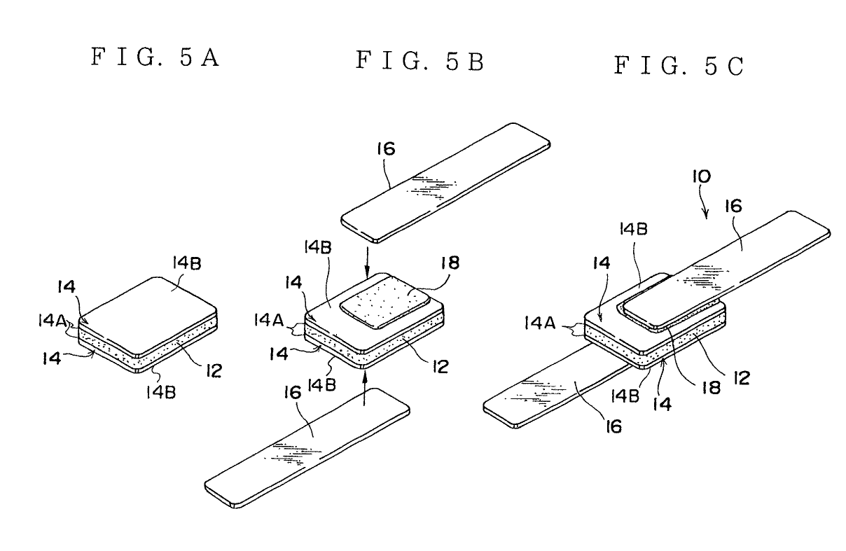

Meanwhile, one surface of each of the pair of the electrode foils 14 shown in FIG. 4A is roughened with the surface roughness Ra of about 1.0 μm to about 1.5 μm to be the surface 14A, and at the same time, the Au flash platings are applied on both surfaces of each of the foils 14 respectively with plating thickness of about 0.01 μm to about 0.1 μm. Then, while the element body 12 is sandwiched between the pair of the electrode foils 14, they are pressed, for example, by a not-shown press machine. Thereby, the pair of the electrode foils 14 can be bonded on the element body 12 in a manner that the surface 14A roughened and applied with the Au flash plating, out of both surfaces of each of the pair of the electrode foils 14, faces the element body 12 as shown in FIG. 4B and FIG. 5A.

As a result, the pair of the electrode foils 14 are in a state of being disposed on the upper and lower surfaces of the element body 12 respectively, and in this state, pasted Sn—Bi alloy soft solders 18 are applied on the electrode foil 14 sides as shown in FIG. 5B (the application only on one of the electrode foils 14 is shown). Through the above-described processes, the aforesaid Au flash platings are also applied on surfaces 14B of the electrode foils 14 which are opposite the element body 12 and on which the Sn—Bi alloy soft solders 18 are applied. However, the pasted Sn—Bi alloy soft solders 18 may be applied on the lead terminal 16 sides.

In the above-described processes, electrolytic copper foils or electrolytic nickel foils, each having one surface roughened, may be used as the electrode foils 14, and foils subjected to roughening and electrolytic nickelic treatment may be used as the electrolytic copper foils.

Thereafter, the pasted Sn—Bi alloy soft solders 18 are once melted by reflowing to soft-solder the electrode foils 14 and the lead terminals 16 by the Sn—Bi alloy soft solders 18 and connect them as shown in FIG. 5C, so that the polymer PTC element 10 is finished.

Specifically, the temperature of the resistance changing point of the element body 12, which is a body portion of this polymer PTC element 10, is in a relatively low temperature range of 60° C. to 120° C., so that the element body 12 is susceptible to thermal influence at the time of this reflowing. However, the melting point of the Sn—Bi alloy soft solders 18 is also in a low temperature range of 139° C. to 160° C., so that the thermal influence given to the element body 12 due to the soft soldering between the electrode foils 14 and-the lead terminals 16 is small.

Incidentally, as a concrete example of the Sn—Bi alloy soft solder 18 in this embodiment, it can be considered to use a lead-free soft solder including Sn, Bi, and Ag (silver), with Bi content being 47% to 64%, Ag content being 0% to 3%, and Sn content being the rest. The reflow peak temperature at the time of the reflowing of this Sn—Bi alloy soft solder 18 is made to be about 160° C. to about 180° C.

Next, the operation of the polymer PTC element 10 according to this embodiment is explained.

In this embodiment, the element body 12 includes the polymer and the conductive material dispersively mixed in this polymer, in which resistance change occurs in the low temperature range of 60° C. to 120° C. The element body 12 is so structured that the pair of the electrode foils 14 are bonded on both of the surfaces of this element body 12 respectively and the pair of these electrode foils 14 and the pair of the lead terminals 16 are connected by the Sn—Bi alloy soft solders 18 respectively.

Moreover, at least one surface of each of the pair of these electrode foils 14 is roughened, and in addition, the Au flash platings are applied on the surfaces 14A which are the roughened surfaces. Then, the electrode foils 14 are bonded on the element body 12 in a manner that the roughened surfaces 14A applied with the Au flash platings face the element body 12. Note that the Au flash platings are also applied on the surfaces 14B of the electrode foils 14 which do not face this element body 12, namely, the surfaces opposite this element body 12 in this embodiment, in order to satisfy solderability.

In other words, the Au flash platings are applied on the roughened surfaces 14A of the electrode foils 14 so that layers of gold which is a stable material with low electrical resistance are disposed in the connecting portions between the element body 12 and the electrode foils 14 of the polymer PTC element 10 according to this embodiment. This not only sufficiently lowers the electrical resistance in these connecting portions compared with the conventional example but also lessens changes due to its environment and aging so that increase in the electrical resistance in the connecting portions is prevented.

As a result, a stable electrical characteristic is obtainable and, in addition, a low-cost electrolytic copper foil can be used so that the production cost of the polymer PTC element 10 can be reduced.

Meanwhile, according to this embodiment, the Au flash platings with a relatively thin plating thickness of about 0.01 μm to about 0.1 μm are also applied on the surfaces 14B of the electrode foils 14 opposite the element body 12, as described above. Therefore, the temperature of the Au flash platings do not become high at the time of the plating so that there is no possibility of causing a poor characteristic of the element body 12 due to thermal degradation. Furthermore, since the plating thickness may be small as described above, the plating does not adhere to the end surface of the element body 12, thereby preventing production of a poor product.

Moreover, the characteristic of the polymer PTC element 10 is not degraded either due to a plating solution or the treatment temperature at the time of the plating, and in addition, since the plating thickness is small, improvement in a process yield and relatively low-cost production can be realized.

As described above, in this embodiment, at least the surfaces of the electrode foils 14 facing the element body 12 are roughened to be the surfaces 14A and the Au flash platings are applied on both of the surfaces of the electrode foils 14, namely, the surfaces 14A and 14B. Consequently, both of the surfaces, namely, the roughened surfaces 14A bonded on the element body 12 and the surfaces 14B onto which the lead terminals 16 are connected are plated respectively.

More specifically, a soft-solder plating may possibly cause a poor characteristic since thick soft solders adhere to the roughened surfaces. Therefore, it is necessary to completely mask one surface of each of the electrode foils during the treatment, while the Au flash plating employed in this embodiment does not have a possibility of causing a poor characteristic owing to its thin plating.

As a result, it is possible to have gold adhere to both of the surfaces of each of the electrode foils 14 at the same time by one plating process, so that the production processes are simplified and the production cost of the polymer PTC element 10 can be further reduced.

Meanwhile, in this embodiment, the element body 12 includes the polymer and the resistance change thereof occurs within the low temperature range of 60° C. to 120° C. Consequently, the element body 12 is easily affected by heat. But the electrode foils 14 disposed on this element body 12 and the lead terminals 16 are connected with each other by the Sn—Bi alloy soft solders 18 with a low melting point of 139° C. to 160° C. Therefore, as a result of employing the Sn—Bi alloy soft solders 18, the electrode foils 14 and the lead terminals 16 can be connected by the reflowing, which is common as a soft soldering process, and in addition, they can be connected while the reflow peak temperature of the soft solder is maintained within a low temperature range of 160° C. to 180° C.

As a result, the thermal influence given to the element body 12 is reduced, thereby eliminating the possibility of causing a poor characteristic due to thermal degradation. In other words, the element body 12 according to this embodiment is easily affected by heat, and the degradation of its characteristic is prominent especially when heat at the temperature of 190° C. or higher is given to it, but since the reflow peak temperature of the soft solder is also in the low temperature range of 160° C. to 180° C., no characteristic degradation due to heat is caused.

Furthermore, the maximum value of the usable temperature range of the polymer PTC element 10 is also suppressed to be about 120° C. lower than 139° C., which is the melting point of the soft solder of 57% Bi whose melting point is the lowest. Therefore, no problem involved in connection such as melting of the soft solder when the polymer PTC element 10 is used does not occur.

Incidentally, the melting point of an ordinary eutectic soft solder which is Sn-37Pb is 183° C. and the reflow peak temperature when it is treated, is about 200° C. to about 220° C. Therefore, the treatment temperature is greatly higher compared with a case when the Sn—Bi alloy soft solder 18 is used as in this embodiment, which gives a great damage to the element body 12 and therefore, this eutectic soft solder is not usable.

As described above, in the polymer PTC element 10 according to this embodiment, the soft soldering process can also be carried out by the ordinary reflowing when the electrode foils 14 and the lead terminals 16 are soft-soldered. Furthermore, influence and deformation by heat at the time of the soft soldering is small, so that not only reliability is further enhanced but also a process yield is enhanced. As a result, the polymer PTC element 10 becomes low-priced.

Next, test results concerning stability of electrical resistance of the polymer PTC element according to the present invention are specifically explained.

First, samples of five kinds of polymer PTC elements are made for testing, a plurality of samples being prepared for each kind. Samples 1 are examples in each of which an electrolytic nickel foil with one surface thereof being roughened is used as an electrode foil. Samples 2 are examples in each of which an electrolytic copper foil is subjected to surface-roughening and electrolytic nickelic treatment as an electrode foil. Samples 3 are examples in each of which an electrolytic copper foil with one surface thereof being roughened is applied with an Au flash plating as an electrode foil. Samples 4 are examples in each of which an electrolytic nickel foil with one surface thereof being roughened is applied with an Au flash plating as an electrode foil. Samples 5 are examples in each of which a foil made by subjecting an electrolytic copper foil to surface-roughening and electrolytic nickelic treatment is applied with an Au flash plating as an electrode foil. Therefore, the samples 3 to the samples 5 among the above samples are samples corresponding to the polymer PTC element of the present invention.

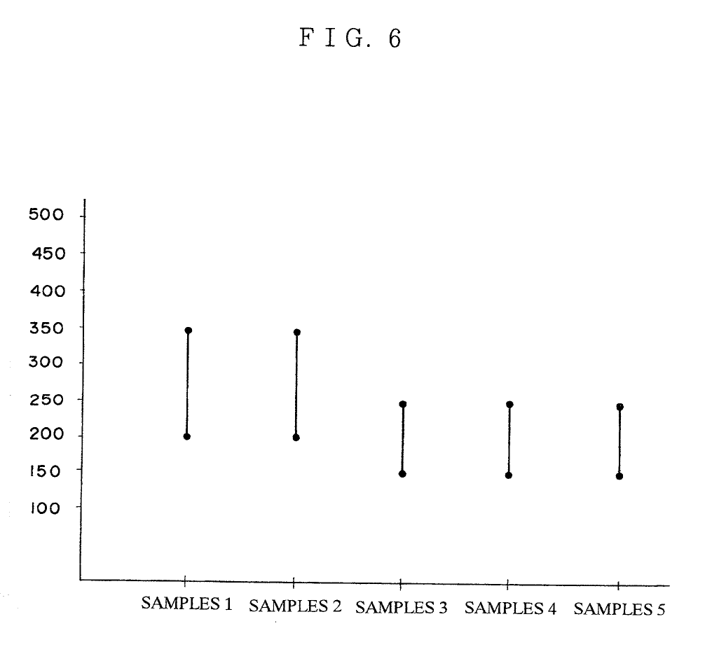

Increase in electrical resistivity after a 100-hour thermo cycle test (a thermo cycle condition: −40° C. to +85° C.) is conducted on each of the above-described samples is shown in the graph in FIG. 6. More specifically, the graph in this drawing shows the increase range of the electrical resistivity of each of the samples after the thermo cycle test, assuming that an initial value of the samples 1 (specifically, 10 mΩ) is 100.

The result of the test shows that the increase ranges are concentrated in the range of 200 to 350 in the samples 1 and 2, while the increase ranges are concentrated in the range of 150 to 250 in the samples 3 to 5. Therefore, the change rate of the electrical resistivity of the samples 3 to 5 corresponding to the polymer PTC element according to the present invention is about half the change rate of the electrical resistivity of the samples 1 and 2, and therefore, it is confirmed that the samples 3 to 5 are very stable.

Next, the test result concerning thickness and strength of the Au flash plating of the polymer PTC element according to the present invention is specifically explained.

First, the correlation between the thickness of the Au flash plating on the surface of the electrode foil which is soft-soldered and the bonding strength of the soft soldering is tested.

As a result of this test, in samples in which the Au flash plating is 0.02 μm to 0.05 μm in thickness (average 0.03 μm), the lead terminals themselves are cut away at about 150 newtons when they are pulled by forces in the directions of the arrows F shown in FIG. 1.

On the other hand, in samples in which the Au flash plating is 0.2 μm to 0.5 μm in thickness (average 0.3 μm), abrasion occurs in soft-solder bonding portions at about 100 newtons when they are similarly pulled by the force in the directions of the arrows F shown in FIG. 1.

Generally, when the Au flash plating is applied, the bonding strength may possibly be lowered due to the dispersion of Au into the soft solder, but the result shows that the plating thickness of about 0.02 μm to about 0.05 μm as described above suppresses the dispersion amount to be small and the influence to the bonding strength of the soft soldering to be small.

The correlation between the thickness of the Au flash plating on the surface of the electrode foil facing the element body and the bonding strength between the element body and the electrode foil is tested.

As a result of this test, in the samples in which the Au flash plating is 0.02 μm to 0.05 μm in thickness (average 0.03 μm), abrasion occurs at about 10 newtons when forces in the directions of the arrows F shown in FIG. 4B are given thereto. At this time, the element bodies themselves are broken, and parts of the element bodies are left bonded on many of the surfaces of the electrode foils facing the element bodies.

On the other hand, in the samples in which the Au flash plating is 0.2μm to 0.5 μm in thickness (average 0.3 μm), abrasion occurs at about eight newtons when the forces in the directions of the arrows F shown in FIG. 4B are similarly given thereto. At this time, some of the element bodies are broken, but the part of the element body left bonded on the surface of the electrode foil facing the element body is smaller than that in the above-described case.

From the above results, it can be considered that proper thickness of the Au flash plating is 0.1 μm or less, and more preferably, the plating thickness is about 0.02 μm to about 0.05 μm, since the bonding strength is lowered when the plating thickness is 0.2 μm or more.

Incidentally, in this embodiment, the surfaces of the electrode foils facing the element body are roughened, and in roughening the surfaces of the electrode foils, it can be considered that protruding portions among recessed and protruding portions constituting the roughened surfaces are formed, for example, in a hook shape. The height of 1 μm or more is sufficient for the hook-shaped protruding portions, and it can be considered that it is made to be, for example, about 4 μm to about 10 μm.

Furthermore, the protruding portions out of the protruding and recessed portions constituting the roughened surfaces can be formed in a hook shape by having granular materials adhere to the surfaces of the electrode foils. Incidentally, it can be considered as treatment for roughening the surfaces of the electrode foils by forming the protruding portions in a hook shape that the surfaces are roughened by treatment such as etching and plating, and thereafter, they are electrolyzed so that an ionized material in an electrolytic solution adheres to top portions of the protruding portions of the roughened surfaces. This facilitates the forming of the protruding portions to be hook-shaped protruding portions.

Meanwhile, the lead-free soft solder including Sn, Bi, and Ag is used as the Sn—Bi alloy soft solder 18, Bi content being 47% to 64%, Ag content being 0% to 3%, and Sn content being the rest. Therefore, since lead is not included therein, the influence given to the environment is small. Moreover, when it includes 3% Ag or less, for example, about 1%, and about 57% Bi, mechanical reliability such as the connecting strength by the soft solder is enhanced. Therefore, it is preferable that how the soft solder is constituted is determined in more detail based on production cost, the structure of the polymer PTC element 10, reliability data, and so on.

Incidentally, in the above-described embodiment, Bi content, namely, bismuth content is in a range of 47% to 64%, Ag content, namely, silver content is 3% or less, and Sn content, namely, tin content is the rest. But an alloy soft solder only of tin-bismuth, non-inclusive of silver may also be used. % signifying their content is WT %.

According to the polymer PTC element of the present invention, the electrical resistance in the connecting portion between the element body and each of the electrodes is sufficiently low, and in addition, the electrical resistance in this connecting portion is not increased due to environmental and aging changes and so on, so that it is given a stable electrical characteristic. Furthermore, not only the possibility of causing a poor characteristic due to thermal degradation is eliminated, but also solderablity of the lead terminal is satisfied.

What is claimed is:

1. A polymer PTC element, comprising:
an element body including a polymer and a conductive material dispersively mixed in this polymer; and
a pair of electrode foils, in each of which at least one surface is roughened and this surface is applied with an Au flash plating and which are bonded, with these surfaces being faced with the element body, on both surfaces of the element body respectively.

2. The polymer PTC element according to claim 1,
wherein the Au flash plating applied on each of the electrode foils has a thickness of 0.01 μm to 0.1 μm.

3. A polymer PTC element, comprising:
an element body including a polymer and a conductive material dispersively mixed in this polymer; and
a pair of electrode foils which are bonded on both surfaces of the element body respectively and in which surfaces opposite the element body are applied with Au flash platings respectively.

4. The polymer PTC element according to claim 3,
wherein the Au flash plating applied on each of the electrode foils has a thickness of 0.01 μm to 0.1 μm.

5. The polymer PTC element according to claim 3,
wherein the Au flash plating applied on each of the electrode foils has a thickness of 0.02 μm to 0.05 μm.

6. The polymer PTC element according to claim 3,
wherein a lead terminal is attached on the surface of the electrode foil opposite the element body by an alloy soft solder.

7. The polymer PTC element according to claim 3,
wherein a pair of lead terminals are attached on the surfaces of the pair of the electrode foils opposite the element body respectively by an alloy soft solder.

8. A polymer PTC element, comprising:
an element body including a polymer and a conductive material dispersively mixed in this polymer; and
a pair of electrode foils which are bonded on both surfaces of the element body respectively and in each of which at least a surface facing the element body is roughened and both surfaces are applied with Au flash platings respectively.

9. The polymer PTC element according to claim 8,
wherein the Au flash plating applied on each of the electrode foils has a thickness of 0.01 μm to 0.1 μm.

10. The polymer PTC element according to claim 8,
wherein the Au flash plating applied on each of the electrode foils has a thickness of 0.02 μm to 0.05 μm.

11. The polymer PTC element according to claim 8,
wherein a lead terminal is attached on the surface of the electrode foil opposite the element body by an alloy soft solder.
